(19) United States
(12) Patent Application Publication
(10) Pub. No.: US 2014/0072160 A1
(43) Pub. Date: Mar. 13, 2014

(54) AMPLIFIER STAND

(71) Applicant: Michael G. PEACOCK, Vacaville, CA (US)

(72) Inventor: Michael G. PEACOCK, Vacaville, CA (US)

(21) Appl. No.: 14/024,183

(22) Filed: Sep. 11, 2013

Related U.S. Application Data
(60) Provisional application No. 61/699,922, filed on Sep. 12, 2012.

(51) Int. Cl. F16M 11/10; H04R 1/02

(52) U.S. Cl. CPC F16M 11/10; H04R 1/02
USPC 381/336; 248/123.11

(57) ABSTRACT

An axis of rotation of a rotatable connection between a rocker arm, attached to the bottom of the amplifier, and a support frame of the amplifier stand is on the centerline of the amplifier box depth. A balance spring arranged between the support frame and the rocker arm is increasing loaded with tilting back of the amplifier on the stand to oppose a fallback load of the amplifier and permit a friction device applying a frictional force dampening the relative rotation to hold the amplifier in a selected tilt angle up to 45°.

### RELATED APPLICATIONS

This application claims priority of provisional application No. 61/699,922 filed Sep. 12, 2012. The entire disclosure of the provisional application No. 61/699,922 is hereby incorporated herein by reference.

### TECHNICAL FIELD

The present invention is directed to an improved stand for an object, particularly an amplifier, a method of using the same, and an amplifier which includes the stand, allowing the amplifier to be tilted back with the touch of a finger and held at a selected angle position.

### BACKGROUND

Musicians have never had a convenient way to tilt their floor mounted amplifiers back so that the amplifiers (also referred to herein as “amp”) point up towards the musician's ears for better hearing during a live performance. For performing musicians the stage is a noisy, hectic work environment during a live performance. It's very difficult to hear one's own instrument above all the other amplified instruments, vocals and drum noise. A musician's job is always easier if he or she can hear their instrument at a volume level above the other instruments. But this cannot be accomplished by simply increasing the volume; that makes their instrument louder for the other musicians and thus more difficult for them to hear their own instruments.

The standard way for musicians to address this problem is to attempt to point or aim their amplifier (with speaker attached inside) up towards their ears. Speakers used in instrument amplifiers are very directional. That is, the sound coming off the front of a speaker is substantially louder than the sound coming off the sides. So tilting the amp and speaker up so it points more towards the musicians ears provides a considerable volume boost which allows the musician to hear his instrument at an elevated volume level above the other instruments. This is important because his instrument sounds louder to him but not to the other musicians or the audience.

However instrument amplifiers are not intended to be tilted back. By design, they are intended to sit on the floor with the speaker pointing straight out to the front.

Over the years there have been many methods employed to tilt an amplifier back. One major manufacturer as far back as the late 1950s employed pressed steel rails or “legs” bolted to the sides of the amplifier box that would pivot backwards thus allowing the amplifier to be tilted back and supported by the rails or legs. There have also been various wood and metal stands which cradle the amplifier at a preset angle. These are generally not popular with musicians due to their size, space taken up on crowded stages and lack of portability. They are also non-adjustable and set at a predetermined angle that may not be right for the musician.

In short most musicians either, do nothing and live with the problem as best they can, or they improvise in some way. The most common improvised way around this problem is simply setting the amplifier on a chair, a barstool, a table, a road case or even another amplifier. Just getting the amplifier off the floor can be beneficial, but on many crowded stages there is just not room for chairs, barstools, or tables. Another common method is leaning the amp back against something on stage like a wall or a backdrop or another piece of equipment. This can also be beneficial but due to their uneven internal weight distribution amplifiers do not lean back well and are always at risk of being knocked over. An aim of the present invention is to solve these problems.

### SUMMARY

The improved amplifier stand of the invention addresses and solves the above-noted problems. In accordance with a disclosed embodiment of the invention, the amplifier stand actively tilts back up to 45° with the push of a finger. It can be set and held at any angle the musician desires up to 45°. The amplifier stand is small, lightweight and fits within the foot of the amp. It takes up no more space on stage than the amplifier itself. The stand attaches securely to the underside of the amplifier box, thus becoming an integral part of the amplifier and saves the musician from hauling a separate piece of equipment.

More particularly, a stand for supporting an object in accordance with the invention comprises a support frame for resting on a surface such as a stage above which the object is to be supported. A rocker arm on which the object can be supported is rotatably connected by a rotatable connection to the support frame to permit tilting back the rocker arm and the object supported on the rocker arm relative to the support frame. A balance spring is arranged between the support frame and the rocker arm such that relative rotation between the rocker arm and the support frame about the rotatable connection with tiling back the rocker arm and the object supported on the rocker arm increases loading of the spring in opposition to a fallback load of the object being tilted back. A device applies a controlled amount of force resisting relative rotation between the rocker arm and the support frame about the rotatable connection for holding the rocker arm and the object supported on the rocker arm at a selected tilted back position.

In the example embodiment described herein, the stand for an amplifier that allows the amplifier to be tilted back and held at a selected angle comprises first and second stand assemblies in accordance with the invention for supporting respective ones of left and right sides of the amplifier. Each stand assembly includes a support frame for resting on a surface above which an amplifier is to be supported, a rocker arm to which the amplifier can be attached, a rotatable connection between the rocker arm and the support frame permitting tilting back an amplifier attached to the rocker arm from an upright position of the amplifier to an adjustable, tilted back position, a balance spring arranged between the support frame and the rocker arm such that relative rotation between the rocker arm and the support frame about the rotatable connection with tilting back an amplifier attached to the rocker arm increases loading of the spring in opposition to a fallback load of the amplifier being tilted back, and a device applying a controlled amount of force resisting relative rotation between the rocker arm and the support frame about the rotatable connection for holding the rocker arm and an amplifier attached thereto at a selected tilted back position.

A further feature of the stand is that the support frame includes a leg extension adjustably extendable from the support frame in a direction of tilting back of an amplifier attached to the rocker arm. Before extension, the stand is compact for transportation and set up, while affording additional stability against being knocked over when extended, particularly where the amplifier is tilted back.

An additional aspect in accordance with the disclosed embodiment is that the support frame of the stand/each stand assembly has first and second upper surfaces arranged to serve as respective mechanical stops against the amplifier supported on the rocker arm are being tilted to respective ones of a forward position and a backward position. These upper surfaces are arranged to permit tilting back to a selected angle of up to 45°.

The balance springs of the stand assemblies have a spring constant selected to balance a fallback load of the amplifier/object being tilted back. This feature together with the device applying a controlled amount of force resisting relative rotation between the rocker arm and the support frame enable the stand to hold the rocker arm and amplifier/object supported therein at a selected angle of tilting back. The controlled force is easily overcome by the musician's applying a finger or hand to change the tilt back position as needed with the stand holding the amplifier in the new position after the adjustment.

These and other objects and features of the invention will be more apparent from the following detailed description of several embodiments of the invention taken with the accompanying drawings.

### BRIEF DESCRIPTION OF THE DRAWINGS

FIG. 1 is a perspective view from above, to rear and side of an amplifier stand/stand assembly of the invention shown in disassembled condition.

FIG. 2 is a perspective view from above, to the rear and side of a support frame/support frame assembly of the amplifier stand of FIG. 1 with a frame, mounting stud, backing plate support, and backing plate thereof depicted in disassembled relation.

FIG. 3 is a perspective view from above, to its rear and side of a rocker arm assembly, shown in disassembled relation, of the stand of FIG. 1 including a rocker arm and an outer bearing race.

FIG. 4 is a perspective view from above, to the rear and side of a leg extension assembly of the stand of FIG. 1.

FIG. 5 is a side elevational view of the assembled stand of FIG. 1 with the leg extension assembly shown in an extended position, in the direction of tilting back of an amplifier when support on the stand as shown in FIG. 8.

FIG. 6 is a perspective view from above, to the rear and side, of the assembled stand as shown in FIG. 5.

FIG. 7 is a perspective view of an amplifier, shown upside down, with one stand attached to the right side of the bottom of the amplifier and a second stand shown in position above the left side of the bottom of the amplifier prior to attachment in the amplifier.

FIG. 8 is a side view of one side of the amplifier of FIG. 7 showing one of the two stands/stand assemblies attached to the bottom of the amplifier with the amplifier in the upright position in solid lines and tilted back from the upright position at two different angles shown in broken lines.

### DETAILED DESCRIPTION

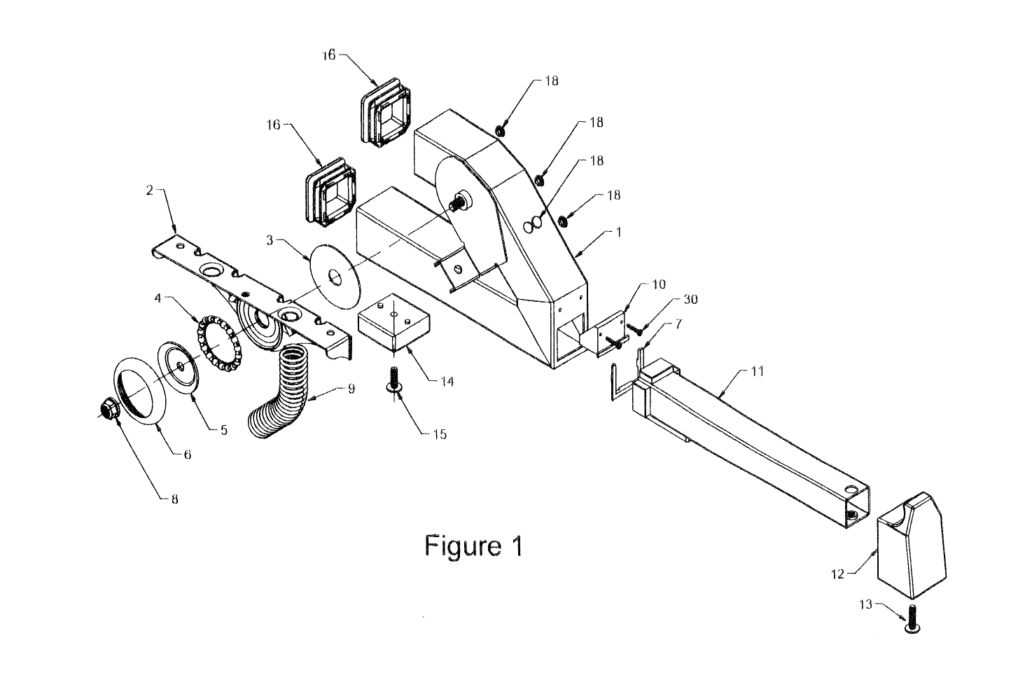

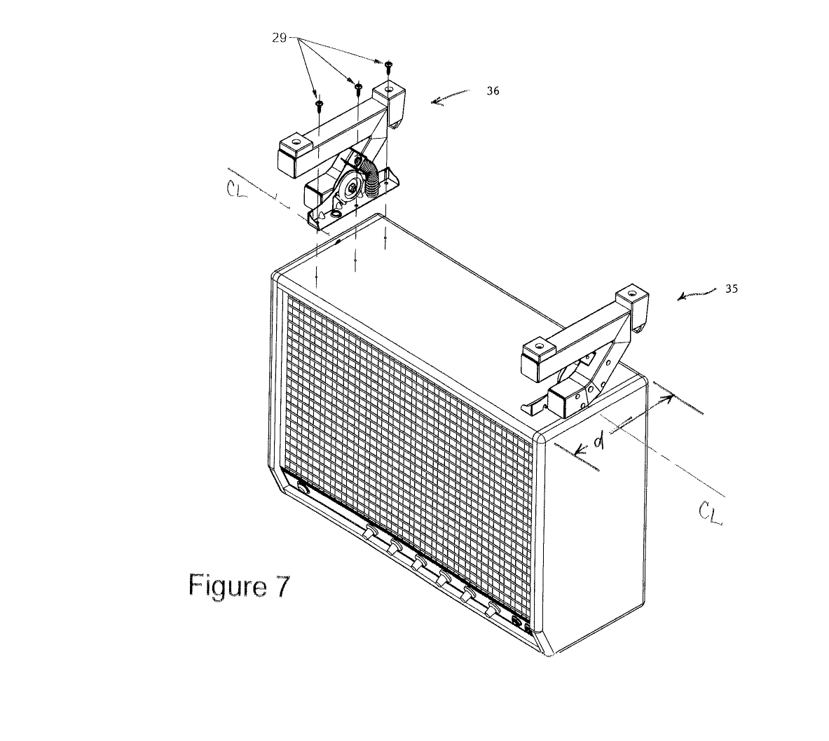

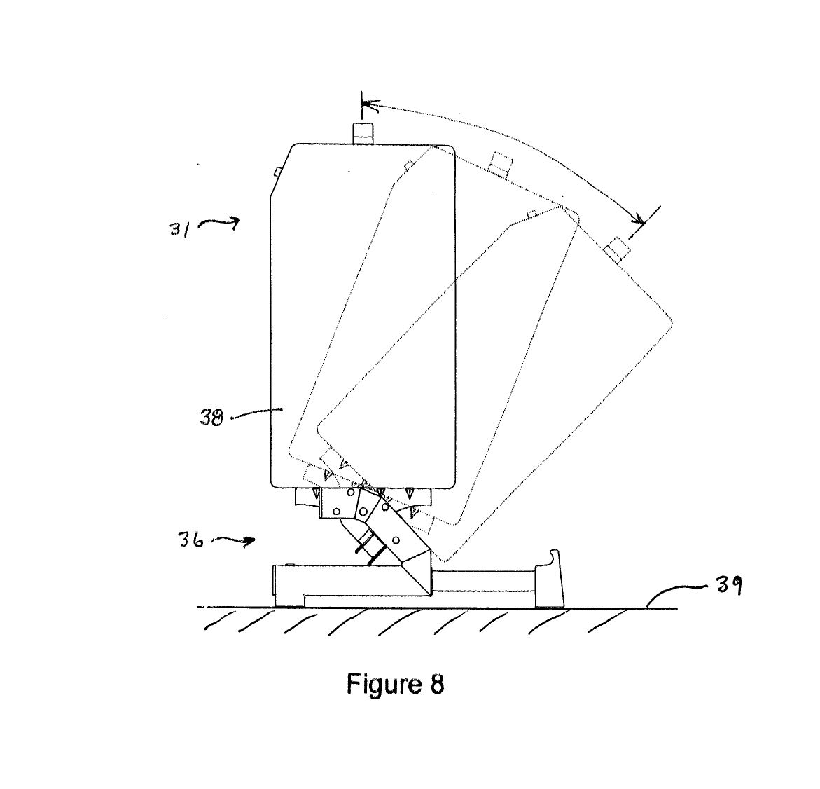

Concerning the design and functionality of the amplifier stand 30 depicted in the drawings, it is recognized that any box (amplifier 31 in FIG. 7) that is taller than it is deep when standing upright can fall back due to the force of gravity. If one took multiple load measurements at a given point on the box as it is falling backwards, one would find the fallback rate to be linear. In accordance with the invention, this fallback rate is matched to a set of compression springs 9 in the stand/stand assemblies having the same rate creating a balanced load condition. A small but controlled amount of friction is applied between the moving parts of the balanced load assembly with a friction device 33 in accordance with the invention. See friction disc 3 of the friction device in FIG. 1. The moving parts are dampened and held in any position with the friction device using minimal force. That is, the stand/stand assemblies employ two compression springs 9 to match the fallback rate of any given amp, a specially designed angular contact ball bearing 4 for friction free rotation, and the controllable friction device 33 which holds the assembly (with amplifier attached) at any angle desired by the musician from upright to 45° backward tilt. See FIG. 8 where amplifier 31 according to the invention with the stand attached to the bottom of the amplifier box 38 resting on a stage 39 is shown in the upright position in solid lines and in two different tilted positions in dotted lines.

More particularly, the stand 30 comprises first and second stand assemblies 35, 36 for supporting respective ones of the left and right sides of amplifier 31. Refer to FIGS. 7 and 8. A rocker arm 24 to which the bottom of the amplifier is attached by screws 39, FIG. 7, is rotatably connected to the support frame by a rotatable connection 37 permitting tilting back relative to the support frame the amplifier attached to the rocker arm as shown in FIG. 8.

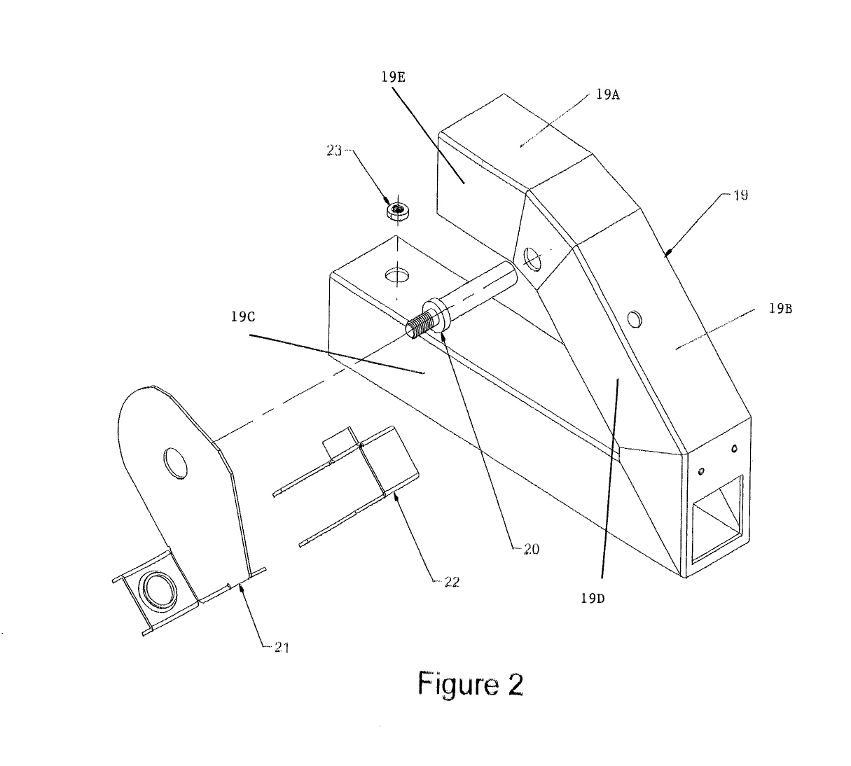

Each stand assembly includes a balance spring 9 arranged between the support frame and the rocker arm such that relative rotation between the rocker arm and the support frame about the rotatable connection with tilting back an amplifier attached to the rocker arm increases loading of the spring in compression in opposition to the fallback load of the amplifier being tilted back. The stand employs two compression springs for the stand assemblies whose spring rates are matched closely to the fallback rate of a given amplifier. Shorter, lighter amplifiers use lower rate springs, and taller, heavier amplifiers use higher rate springs. One end of the balance spring 9 mounts to a stationary backing plate 21 on the frame assembly as shown in FIG. 2. The other end of the spring mounts to the rocker arm assembly 2 as seen in FIG. 1. The amplifier 31 attaches directly to the rocker arm assembly and as the amp is tilted back the rocker arm rotates and compresses the balance spring. As the amplifier's fallback load increases with angle the balancing load increases with compression of the balance spring. Thus the amplifier stays balanced at any point in its 45° of travel.

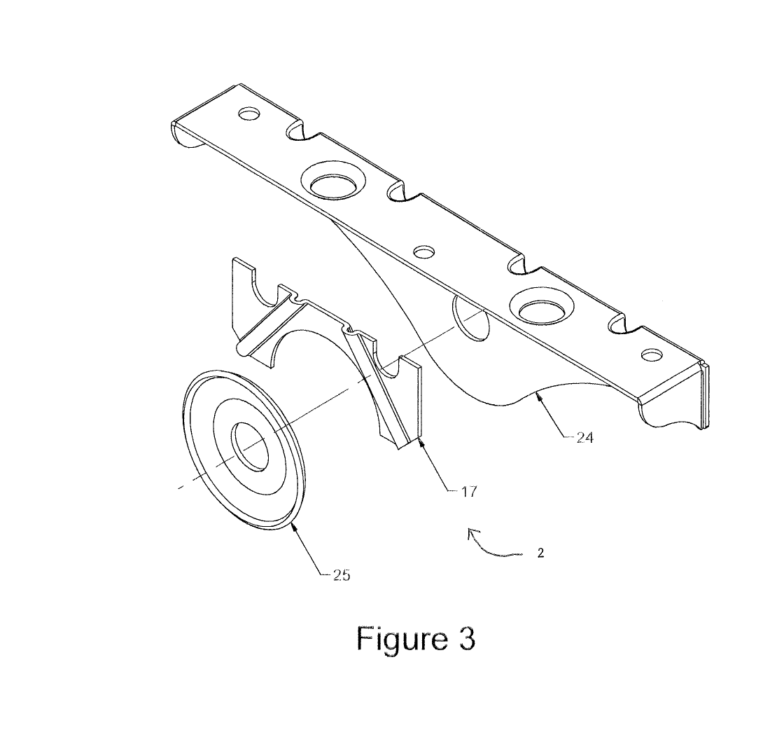

The rotatable connection 37 includes a specially designed 30° angular contact ball bearing 34 having stamped, formed, and hardened steel races 5, 25. The outer bearing race 25 shown in FIG. 3 is attached to the rocker arm 24, creating the rotating rocker arm assembly 2 and the inner bearing race/spring washer 5 bolts down to a stationary stud 20 of the frame assembly 1. The inner bearing race/spring washer 5 also doubles as a Belleville washer or disc spring which supplies a specific amount of load for the friction device 33. This same load is also applied to the bearing. This lateral or compressive load holds the bearing aligned at the 30° contact angle and thus resists radial loads from the weight of the amplifier which would cause the bearing to become misaligned. As a heavier (and taller) amp with a higher radial load would also require more friction and thus a higher lateral load, the design stays balanced with lateral bearing aligning loads always overcoming radial misaligning loads.

The stud 20 and backing plate 21 seen in FIG. 2 are both welded to the frame 19 forming the frame assembly of the amp stand. A friction disc 3 made from Delran AF is located between the stationary backing plate 21 of the frame assembly and the rotating rocker arm assembly 2. As lateral load is generated from compressing the inner bearing race/spring washer 5, the load is ultimately applied to the backing plate. This causes the friction disc 3 to be loaded or squeezed between the stationary frame assembly 1 and the rotating rocker arm assembly 2, and thus a frictional shear force is produced dampening the rotational movement of the rocker arm assembly 2 and the amplifier 31 to which it is attached against the fallback load when the amplifier is tilted.

To ensure that the amplifier 31 will not fall backwards when tilted back to 45°, the stand 30 is provided with rear leg extensions integrated into the rocker amp stand, e.g. telescoped within hollow lower section 19C of the frame 19 through a square hole 40 in the rear portion of the frame. The square hole is framed with a nylon extension tube hole frame 7 on three sides, FIG. 1, forming a square opening through which the leg extension assembly 11 can be pulled out. A rear foot 12 is attached at one end of the leg extension assembly with a radiused finger grab portion for easy extraction of the leg extension assembly.

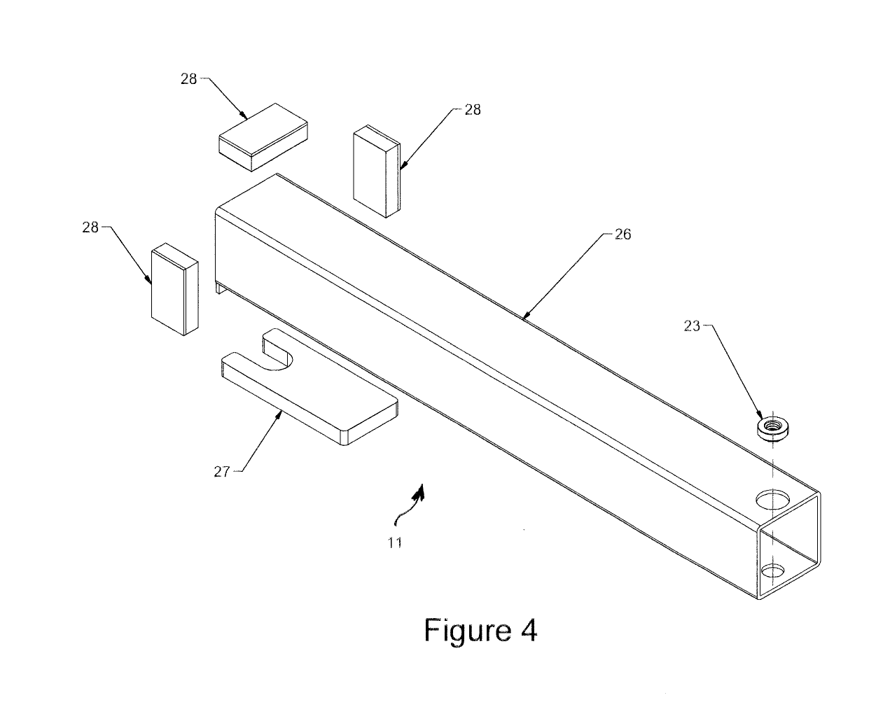

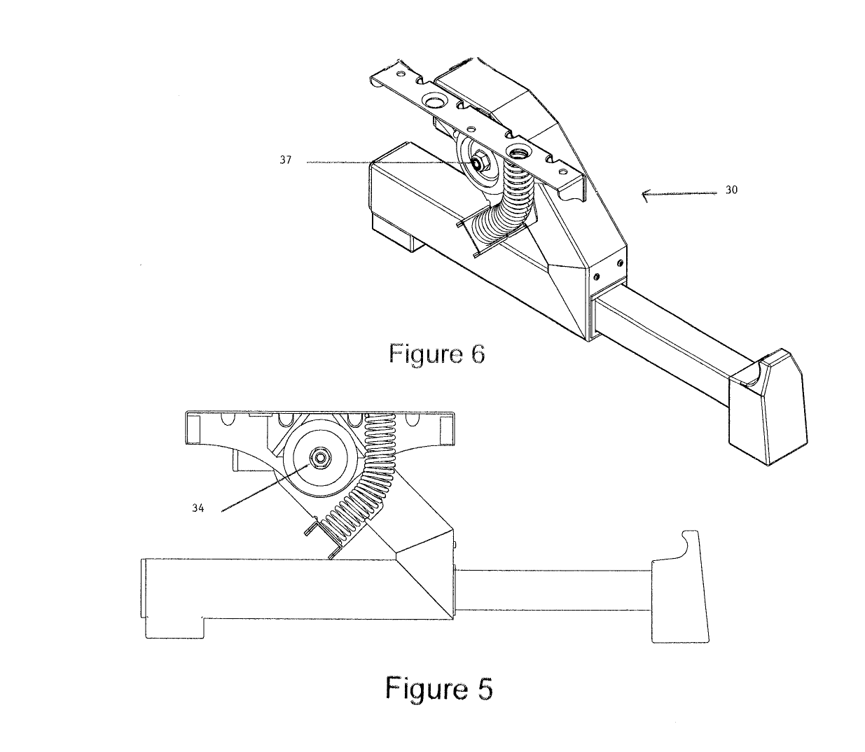

To keep the leg extension assembly fully retracted or extended three friction pads 28 are employed to dampen the leg extension assembly's back-and-forth movement. The leg extension friction pads 28, FIG. 4, are composed of urethane foam with high-density polyethylene bonded to one side and a pressure sensitive adhesive on the other. These three leg extension friction pads are then attached to both sides and top at the front end of the leg extension tube 26. When the leg extension assembly is inserted into the frame assembly, the urethane foam compresses and loads the high density polyethylene against the inside wall of the frame assembly and thus a frictional shear force is produced which dampens the back and forth movement of the leg extension assembly.

To ensure that the leg extension assembly stays parallel with the frame assembly when fully extended, a leg extension bearing pad 27 is attached to the underside of the leg extension tube 26. Unlike the leg extension friction pads 28, the leg extension bearing pad 27 has no foam but is of high-density polyethylene and does not compress. By careful vertical adjustment of the extension tube hole in the frame assembly, it becomes possible to keep the leg extension assembly completely parallel with the frame assembly when it is fully extended with a load applied from the backwards leaning amplifier.

For additional support of the leg extension assembly 11 insuring it stays parallel to the frame assembly 1 when fully extended, a frame bearing pad 10 is securely attached by way of two screws 41 to the top side of the square hole 40 through which the leg extension assembly extends. The rearward portion of the frame bearing pad 10 extends outward thru the square leg extension hole 40 and hooks around the frame hole to form the top portion of the leg extension hole plastic frame 7.

The plastic frame 7 and frame bearing pad 10 around the leg extension hole 40 serve as a bearing, eliminating metal to metal contact between the frame assembly and leg extension assembly when extending or retracting the leg extension assembly. It also helps keep the leg extension assembly aligned laterally when fully extended whereas the leg extension bearing pad and the frame bearing pad keep the leg extension assembly parallel to the frame when fully extended and bearing the load of a tilted amplifier.

There are no mechanical stops built into rotating assembly of the stand 30. When tilting an amplifier 31 with the stand attached, the amplifier box 38 comes to rest in the forward and backward positions against respective upper surfaces 19A and 19B on the frame 19 which serve as mechanical stops stopping the amplifier in the respective positions. The surface 19A is horizontal and the surface 19B is inclined at an angle of 45° from horizontal to permit the 45° range of possible tilting back positions for the amplifier as depicted in FIG. 8 with rotation of the rocker arm and amplifier thereon at the rotatable connection 37 relative to the support frame 19. To provide the surfaces 19A and 19B as stops, the support frame 19 of each stand assembly has a lower section 19C extending in an amplifier box depth direction of an amplifier supported on the stand, an inclined section 19D extending upward and forward from a back end of the lower section to above a mid-portion of the lower section, and an upper section 19E extending forward above the lower section from an upper end of the inclined section. The rotatable connection 37 of each stand assembly is supported at an upper end of the inclined section 19B.

Feet 12, 14 are standard compression molded SBR rubber with a molded in steel washer for compression support. Frame assembly 1 and leg extension assembly 11 both have captive nuts 23, FIGS. 2 and 4, installed. Both front and rear feet attach to the frame assembly 11 and leg extension assembly 11 by way of machine screws 13, 15, FIG. 1, into the captive nuts.

The stand 30 attaches to the bottom of any instrument amplifier by way of three each, ¾ inch long, self-tapping screws 29, FIG. 7, securing the rocker arm assembly 2 to the bottom of the amplifier. The stand is preferably mounted to the bottom of the box so that the stud 20, the axis of rotation of the rocker arm about the rotatable connection 37 relative to the support frame during tilting adjustment, is on the centerline CL of the box depth, as shown in FIG. 7. Both left and right stand assemblies should be mounted perpendicular to the box centerline CL. The edge of the frame assembly 1, FIG. 1, should be flush with the side of the amplifier box. Three each, % inch long, self-tapping screws 29, FIG. 7, are installed through the holes in the rocker arm assembly 2 into the box and tightened down snuggly. The stand is thus securely attached to the amplifier box and can now be used and transported as a single unit. Table 1 below lists reference numbers and associated parts of the example embodiment shown in the drawings.

TABLE 1

| | |
|---|---|
| Pan Head Screws | 41 |
| Square Hole | 40 |
| Stage | 39 |
| Amplifier Box | 38 |
| Rotatable Connection | 37 |
| Second Stand Assembly | 36 |
| First Stand Assembly | 35 |
| Angular Contact Ball Bearing | 34 |
| Friction Device | 33 |
| Angular Contact Ball Bearing | 32 |
| Amplifier | 31 |
| Stand | 30 |
| Oval Head Screw | 29 |
| Leg Extension Friction Pad | 28 |
| Leg Extension Bearing Pad | 27 |
| Leg Extension Bent Tangs | 26 |
| Outer Bearing Race | 25 |
| Rocker Arm | 24 |
| Captive Nut | 23 |
| Backing Plate Support, Left | 22 |
| Backing Plate, Flat Left | 21 |
| Mounting Stud | 20 |
| Frame, Amp Stand, Left | 19 |
| Closure Hole | 18 |
| Rocker Arm Brace | 17 |
| Cap. Sq. | 16 |
| Screw, Machine | 15 |
| Front Foot | 14 |
| Screw, Machine | 13 |
| Rear Foot | 12 |
| Leg Extension Assembly | 11 |
| Frame Bearing Pad | 10 |
| Spring, Coil | 9 |
| Locknut | 8 |
| Extension Tube Hole Edging Frame | 7 |
| Seal, Bearing Race | 6 |
| Inner Bearing Race - Spring Washer | 5 |
| Ball Retainer Assembly | 4 |
| Friction Disc | 3 |
| Rocker Arm Assembly | 2 |
| Frame Assembly, Amp Stand, Left | 1 |

While the example embodiment of the stand disclosed herein employs two separate stand assemblies for the two sides of the amplifier, it is envisioned that a single stand assembly or more than two stand assemblies, could be used, separately or integrated in a single structure depending upon the application. The stand of the invention is advantageously applicable to instrument amplifiers which, by design, are intended to sit on the floor with the speaker pointing straight out in front when the amplifier is in an upright position. However, the stand could be used to support other objects to facilitate their being easily tilted back and held in any selected position of tilt up to 45°. Thus, it should be understood, of course, that the foregoing relates to exemplary embodiments of the invention and that modifications may be made without departing from the spirit and scope of the invention as set forth in the following claims.

I claim:

1. A stand for an object that allows the object to be tilted back and held at a selected angle, the stand comprising:
a support frame for resting on a surface above which an object is to be supported,
a rocker arm on which the object can be supported, the rocker arm being rotatably connected by a rotatable connection to the support frame permitting tilting back the rocker arm and an object supported on the rocker arm relative to the support frame from an upright position of the object to an adjustable, tilted back position,
a balance spring arranged between the support frame and the rocker arm such that relative rotation between the rocker arm and the support frame about the rotatable connection with tilting back the rocker arm and an object supported on the rocker arm increases loading of the spring in opposition to a fallback load of the object being tilted back, and
a device applying a controlled amount of force resisting relative rotation between the rocker arm and the support frame about the rotatable connection for holding the rocker arm and the object supported on the rocker arm at a selected tilted back position.

2. The stand according to claim 1, wherein the support frame includes a leg extension adjustably extendable from the support frame in a direction of tilting back of the rocker arm and an object supported on the rocker arm.

3. The stand according to claim 1, wherein the support frame has first and second upper surfaces arranged to serve as mechanical stops against an object supported on the rocker arm being moved to respective ones of a forward, upright position and a backward, tilted position.

4. The stand according to claim 1, wherein the stand allows an object supported on the rocker arm to be tilted back at a selected angle up to 45° with the push of a finger and held at the selected angle.

5. The stand according to claim 1, wherein the balance spring has a spring constant selected to balance a fallback load of an object being tilted back.

6. The stand according to claim 1, wherein the device applying a controlled amount of force includes a friction disc between the rotatable rocker arm and the support frame, and means for applying a force compressing the friction disc between the rotatable rocker arm and the support frame for generating a frictional force dampening relative rotation between the rocker arm and the support frame about the rotatable connection for holding the rocker arm and an object supported on the rocker arm at a selected tilted back position.

7. The stand according to claim 6, wherein the means for applying a force includes a spring washer.

8. The stand according to claim 7, wherein the spring washer is in the form of a bearing race of a bearing of the rotatable connection, a force applied by the spring washer maintaining bearing alignment and compressing the friction disc for holding the rocker arm and an object supported on the rocker arm at a selected angle of tilting back.

9. The stand according to claim 1, wherein the rotatable connection comprises an angular contact ball bearing which is compressively loaded to resist radial loads from the weight of an object supported on the rocker arm which would cause the bearing to become misaligned.

10. The stand according to claim 1, including means for attaching an object to the rocker arm.

11. A stand for an amplifier that allows the amplifier to be tilted back and held at a selected angle, the stand comprising:
first and second stand assemblies for supporting respective ones of left and right sides of an amplifier, each stand assembly including
a support frame for resting on a surface above which an amplifier is to be supported,
a rocker arm to which the amplifier can be attached,
a rotatable connection between the rocker arm and the support frame permitting tilting back an amplifier attached to the rocker arm relative to the support frame from an upright position of the amplifier to an adjustable, tilted back position,
a balance spring arranged between the support frame and the rocker arm such that relative rotation between the rocker arm and the support frame about the rotatable connection with tilting back an amplifier attached to the rocker arm increases loading of the spring in opposition to a fallback load of the amplifier being tilted back,
a device applying a controlled amount of force resisting relative rotation between the rocker arm and the support frame about the rotatable connection for holding the rocker arm and an amplifier attached thereto at a selected tilted back position.

12. The stand according to claim 11, wherein the support frame of each stand assembly includes a leg extension adjustably extendable from the support frame in a direction of tilting back of an amplifier attached to the rocker arm of the stand assembly.

13. The stand according to claim 11, wherein the support frame of each stand assembly has first and second upper surfaces arranged to serve as mechanical stops against an amplifier attached to the rocker arm being tilted to respective ones of a forward position and a backward position.

14. The stand according to claim 11, wherein the device applying a controlled amount of force includes a friction disc between the rotatable rocker arm and the support frame, and means for applying a force compressing the friction disc between the rotatable rocker arm and the support frame for generating a frictional force dampening relative rotation between the rocker arm and the support frame about the rotatable connection for holding the rocker arm and an amplifier supported on the rocker arm at a selected tilted back position.

15. The stand according to claim 14, wherein the means for applying a force includes a spring washer.

16. The stand according to claim 15, wherein the spring washer is in the form of a bearing race of a bearing of the rotatable connection, a force applied by the spring washer maintaining bearing alignment and compressing the friction disc for holding the rocker arm and an amplifier attached to the rocker arm at a selected angle of tilting back.

17. The stand according to claim 11, wherein the balance springs of the stand assemblies have spring constants selected to balance a fallback load of an amplifier being tilted back.

18. The stand according to claim 11, wherein the stand allows an amplifier attached to the rocker arm to be tilted back at a selected angle up to 45° with the push of a finger and held at the selected angle.

19. The stand according to claim 11, wherein the rotatable connection of each stand assembly comprises an angular contact ball bearing which is compressively loaded to resist radial loads from the weight of an amplifier attached to the rocker arm which would cause the bearing to become misaligned.

20. The stand according to claim 11, wherein the support frame of each stand assembly has a lower section extending in an amplifier box depth direction of an amplifier supported on the stand, an inclined section extending upward and forward from a back end of the lower section to above a mid-portion of the lower section, and an upper section extending forward above the lower section from an upper end of the inclined section, and wherein the rotatable connection of the stand assembly is supported at an upper end of the inclined section.

21. A method of supporting an object on a stand so that the object can be adjustably tilted back and held at a selected angle of tilt, the method comprising use of the stand according to claim 1 for supporting the object.

22. An amplifier which can be tilted back and held at a selected angle, the amplifier comprising:
a box containing a speaker,
first and second stand assemblies for supporting respective ones of left and right sides of the amplifier, each stand assembly including
a support frame for resting on a surface above which the amplifier is to be supported,
a rocker arm to which the box of the amplifier is attached,
a rotatable connection between the rocker arm and the support frame permitting tilting back the amplifier relative to the support frame from an upright position of the amplifier to an adjustable, tilted back position,
a balance spring arranged between the support frame and the rocker arm such that relative rotation between the rocker arm and the support frame about the rotatable connection with tilting back the amplifier attached to the rocker arm increases loading of the spring in opposition to a fallback load of the amplifier being tilted back,
a device applying a controlled amount of force resisting relative rotation between the rocker arm and the support frame about the rotatable connection for holding the rocker arm and the amplifier at a selected tilted back position.

23. The amplifier according to claim 22, wherein an axis of rotation of the rotatable connection of each of the first and second stand assemblies is on a centerline of the amplifier box depth.
